(19) United States
(12) Patent Application Publication
(10) Pub. No.: US 2020/0183605 A1
(43) Pub. Date: Jun. 11, 2020

(54) EXTENT BASED RAID ENCODING

(71) Applicant: EXTEN Technologies, Inc., Austin, TX (US)

(72) Inventors: Michael J. Enz, Fargo, ND (US); Ashwin Kamath, Cedar Park, TX (US)

(21) Appl. No.: 16/703,620

(22) Filed: Dec. 4, 2019

Related U.S. Application Data
(60) Provisional application No. 62/775,706, filed on Dec. 5, 2018.
(60) Provisional application No. 62/775,702, filed on Dec. 5, 2018.

(51) Int. Cl. G06F 3/06

(52) U.S. Cl. CPC G06F 3/0644; G06F 3/0689; G06F 3/0659; G06F 3/0619

(57) ABSTRACT

Systems and methods for RAID data storage in which each write request identifies a user address and a data length, the system determining a RAID encoding that meets the user's service level requirements, selecting disks to which the data will be written, and writing the data to the disks using the identified RAID encoding. The system may store the metadata for the write in a metadata tree in which the key includes the user address and data length, and the corresponding value includes the physical address(es) of the data on the disks and the RAID encoding used to write the data. The system may use less than all of the disks to store the data, and different writes may use different RAID encodings and different disks (or different numbers of disks), and may be mapped to different addresses on different drives.

### RELATED APPLICATIONS

This application claims the benefit of priority to U.S. Provisional Patent Application No. 62/775,706 filed on Dec. 5, 2018, by inventor Ashwin Kamath entitled “Extent Based Raid Encoding”, and claims the benefit of priority to U.S. Provisional Patent Application No. 62/775,702 filed on Dec. 5, 2018, by inventor Michael Enz entitled “Flexible Raid Drive Grouping Based on Performance”, the entire contents of which are hereby fully incorporated by reference herein for all purposes.

### TECHNICAL FIELD

This disclosure relates generally to the field of data storage, and more particularly to systems and methods for encoding data across a set of RAID drives based on a user address and data length.

### BACKGROUND

Data represents a significant asset for many entities. Consequently, data loss, whether accidental or caused by malicious activity, can be costly in terms of wasted manpower, loss of goodwill from customers, loss of time and potential legal liability. To ensure proper protection of data, it may be possible to implement a variety of techniques for data storage that provide redundancy or performance advantages. In some cases, storage systems allow data to be safely stored even when the data storage system experiences hardware failures such as the failure of one of the disks on which the data is stored. In some cases, storage systems may be configured to improve the throughput of host computing devices.

One technique used in some data storage systems is to implement a Redundant Array of Independent Disks (RAID). Generally, RAID systems store data across multiple hard disk drives or other types of storage media in a redundant fashion to increase reliability of data stored by a computing device (which may be referred to as a host). The RAID storage system provides a fault tolerance scheme which allows data stored on the hard disk drives (which may be collectively referred to as a RAID array) by the host to survive failure of one or more of the disks in the RAID array.

To a host, a RAID array may appear as one or more monolithic storage areas. When a host communicates with the RAID system (e.g., reads from the system, writes to the system, etc.) the host communicates as if the RAID array were a single disk. The RAID system processes these communications in a way that implements a certain RAID level. These RAID levels may be designed to achieve some desired balance between a variety of tradeoffs such as reliability, capacity, speed, etc.

For example, RAID level 0 (which may simply be referred to as RAID 0) distributes data across several disks in a way which gives improved speed and utilizes substantially the full capacity of the disks, but if one of these disks fails, all data on that disk will be lost. RAID level 1 uses two or more disks, each of which stores the same data (sometimes referred to as “mirroring” the data on the disks). In the event that one of the disks fails, the data is not lost because it is still stored on a surviving disk. The total capacity of the array is substantially the capacity of a single disk. RAID level 5 distributes data and parity information across three or more disks in a way that protects data against the loss of any one of the disks. In RAID 5, the storage capacity of the array is reduced by one disk (for example, if N disks are used, the capacity is approximately the total capacity of N−1 disks).

One problem with conventional RAID data storage systems is that, for a particular user, the systems normally use a particular RAID encoding corresponding to that user for each of the user's accesses to the system. This particular RAID encoding may be well suited to some types of accesses, but not very well suited to other types of accesses. For example, a system may be configured to use a RAID 5 encoding scheme using 4 drives for a user. If the user has to write data that fills an entire stripe across the RAID drives, this scheme may be very efficient, but if the write has only a small amount of data, the need to read the stripe, update the parity information and write the data to the stripe may cause the scheme to be inefficient.

### SUMMARY

The present systems and methods are intended to reduce or eliminate one or more of these problems of conventional RAID systems by providing a system in which the user identifies a user address and a length of the data to be written, then the system determines a RAID encoding that meets the user's service level requirements and writes the data to the storage disks according to the identified RAID encoding. In one embodiment, the system stores the metadata for the data in a metadata tree in which the key of the entry includes the user address and data length, and the value corresponding to the key includes the physical address(es) of the data on the disks and the RAID encoding used to write the data. The system may use less than all of the disks to store the data, and different writes may use different disks (or different numbers of disks) and may be mapped to different addresses on different drives.

One embodiment comprises a system for data storage having a plurality of RAID storage drives and a storage engine coupled to the drives. The storage engine in this embodiment is configured to receive write requests from a user to write data on the storage drives. Each of the write requests specifies a user address of the data and a length of the data. The storage engine is configured to determine a corresponding RAID encoding for the write based at least in part on the identified length of the data to be written. The RAID encoding may also be determined based in part on a service level indicated by the user, which may include a redundancy level and an access speed. The storage engine is also configured to determine the physical address(es) at which the data will be written on the plurality of storage drives based at least in part on the identified user address and the number of drives that are required for the selected RAID encoding. The physical address(es) for the data may also be based in part on the availability of storage space on the drives and the loading of each of the drives (e.g., as indicated by a queue depth of each drive).

Different write requests may be written to different sets of storage drives (e.g., different numbers of drives, or different subsets of drives). The data for a write may be stored on less than all of the drives in the system. Each write may be mapped to different addresses on the different storage drives, rather than being confined to a single stripe across all of the drives. The RAID encodings corresponding to different write requests may also be different. The storage engine may be configured to maintain a metadata tree to store metadata for the write data, where each entry in the metadata tree may have a user address and data length for the key and may have as the value drive addresses at which the data is written on the storage drives, as well as a RAID encoding with which the data is written to the drives.

The storage engine may be configured to receive read requests from a user to read data from the storage drives, where each of the read requests identifies a corresponding starting user address and a length of data to be read from the storage drives. For each read request, the storage engine may be configured to identify an entry of the metadata tree having the user address as the key, identify the physical addresses corresponding to the identified entry, identify the RAID encoding corresponding to the identified entry, and read the data from the storage drives at the corresponding physical addresses.

Another alternative embodiment comprises a method for RAID data storage. This method includes receiving requests to write data on one or more of a plurality of storage drives. Each of the write requests identifies a corresponding starting user address and a length of data to be written on the storage drives. The method includes, for each of the write requests, determining a corresponding RAID encoding based at least in part on the identified length of the data to be written. Then, corresponding physical addresses at which the data will be written on the plurality of storage drives is determined based at least in part on the identified user address. The data is then stored on the drives at the corresponding physical addresses using the corresponding RAID encoding. The method may use different RAID encodings for different write requests.

The RAID encoding corresponding to each write request may be determined based in part on a service level indicated by the user, which may include a redundancy level and an access speed. The storage drive addresses to which the data will be written may be determined based on availability of storage space on the plurality of storage drives and the loading of the drives (e.g., as determined by a metric such as the weighted queue depth of each drive). The method may involve writing to different physical addresses on different ones of the drives, and data may be written to less than all of the drives in the system. The method may include maintaining a metadata tree, where for each write request, the metadata tree has a corresponding entry where the key includes the user address and a data length, and the value includes the corresponding physical address(es) and an identification of the RAID encoding.

The method may further include receiving read requests from a user to read data from the storage drives, each of the requests identifying a corresponding starting user address and a length of data to be read from the drives. For each read request, the method may include identifying an entry of the metadata tree having the user address as the key, identifying the physical address(es) corresponding to the identified entry, identifying a RAID encoding corresponding to the identified entry, and reading the data from the plurality of drives at the corresponding physical address(es).

Numerous other embodiments are also possible.

### BRIEF DESCRIPTION OF THE DRAWINGS

The drawings accompanying and forming part of this specification are included to depict certain aspects of the invention. A clearer impression of the invention, and of the components and operation of systems provided with the invention, will become more readily apparent by referring to the exemplary, and therefore nonlimiting, embodiments illustrated in the drawings, wherein identical reference numerals designate the same components. Note that the features illustrated in the drawings are not necessarily drawn to scale.

FIG. 1 is a diagram illustrating a multi-core, multi-socket server with a set of NVME solid state drives in accordance with one embodiment.

FIGS. 2A and 2B are diagrams illustrating the striping of data across multiple drives using conventional RAID encodings.

FIGS. 3A and 3B are diagrams illustrating the contents of metadata table structures for user volumes using conventional RAID encodings as illustrated in FIGS. 2A and 2B.

FIG. 4 is a diagram illustrating an example of a write IO an exemplary system in accordance with one embodiment.

FIG. 5 is a diagram illustrating metadata that is stored in a metadata tree in accordance with one embodiment.

FIG. 6 is a diagram illustrating a tree structure that is used to store metadata in accordance with one embodiment.

### DETAILED DESCRIPTION

The invention and the various features and advantageous details thereof are explained more fully with reference to the nonlimiting embodiments that are illustrated in the accompanying drawings and detailed in the following description. Descriptions of well-known starting materials, processing techniques, components and equipment are omitted so as not to unnecessarily obscure the invention in detail. It should be understood, however, that the detailed description and the specific examples, while indicating preferred embodiments of the invention, are given by way of illustration only and not by way of limitation. Various substitutions, modifications, additions and/or rearrangements within the spirit and/or scope of the underlying inventive concept will become apparent to those skilled in the art from this disclosure.

As noted above, data is a significant asset for many entities, and it is important for these entities to be able to prevent the loss of this asset. Conventional RAID data storage systems provide a useful tool to combat data loss, but these systems may still have problems that impact the performance of data accesses. For example, if the system is configured to write data in stripes across four drives, requests to write small amounts of data may be very inefficient. For instance, if the data to be written occupies only the sectors of one drive, the sectors of one or more of the other drives may remain unused. When this data is updated, it may be necessary to read all of the sectors in the stripe (even though some are unused) so that the parity for the updated data can be computed and then written to one of the drives. By comparison, if simple data mirroring were used, it would not be necessary to read the entire stripe—the updated data could simply be written to two drives, which would be more efficient.

This problem is addressed in embodiments of the present invention by providing a RAID data storage system in which user writes specify an “extent” which identifies a user address and a length of the data to be written. The user address is a virtual address in a volume allocated to the user on the system, rather than a physical address. The data storage determines an encoding for the data based on the length of the data to be written and the performance requirements of the user (e.g., redundancy and access speed), and then determines the physical location(s) to which the data will be written on the drives of the data storage system. The encoding of each data write is determined independently of other writes by the user, and the physical location(s) at which the data is written need not be constrained to a particular stripe across all of the system's drives. The system can therefore select an encoding and a physical location for the data write that improves the efficiency of the write, both in terms of speed and utilization of the available drive space.

Thus, for example, if the user has a large amount of data to be written, the system may determine that the most efficient RAID encoding scheme is RAID 5, which uses N drives (N−1 for data and 1 for parity), and may write the data across the N (e.g., four) drives. If, on the other hand, the user has only a small amount of data to be written (e.g., one or two sectors), it may be more efficient to use a RAID 1 encoding which mirrors the data on two of the drives. This could avoid wasting storage space on the other drives that would occur if a stripe was written across all N drives. This could also avoid delays that might arise from having to read, recompute and write parity bits, or from waiting for data to fill space in a stripe across all of the drives.

The RAID data storage techniques disclosed herein may be implemented in a variety of different storage systems that use various types of drives and system architectures. The particular data storage systems described below are provided as non-limiting examples. The techniques described here work with any type, capacity or speed of drive, and can be used in data storage systems that have any suitable structure or topology.

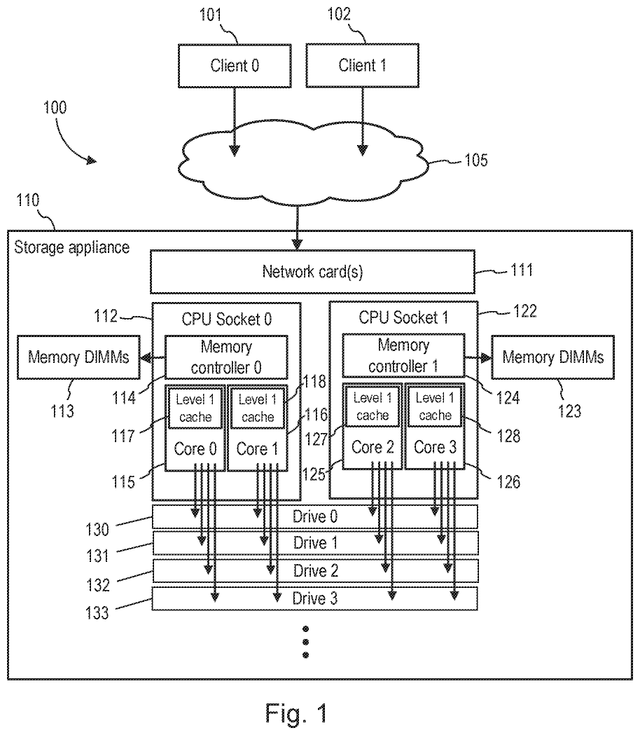

Referring to FIG. 1, an exemplary RAID data storage appliance in accordance with one embodiment is shown. In this embodiment, a multi-core, multi-socket server with a set of non-volatile memory express (NVME) solid state drives is illustrated. In an exemplary system 100, multiple client computers 101, 102, etc., are connected to a storage appliance 110 via a network 105. The network 105 may use an RDMA protocol, such as, for example, ROCE, iWARP, or Infiniband. Network card(s) 111 may interconnect the network 105 with the storage appliance 110.

Storage appliance 110 may have one or more physical CPU sockets 112, 122. Each socket 112, 122 may contain its own dedicated memory controller 114, 124 connected to dual in-line memory modules (DIMM) 113, 123, and multiple independent CPU cores 115, 116, 125, 126 for executing code. The CPU cores may implement a storage engine that acts in conjunction with the appliance's storage drives to provide the functionality described herein. The DIMM may be, for example, random-access memory (RAM). Each core 115, 116, 125, 126 contains a dedicated Level 1 (L1) cache 117, 118, 127, 128 for instructions and data. Each core 115, 116, 125, 126 may use a dedicated interface (submission queue) on a NVME drive.

Storage appliance 110 includes a set of drives 130, 131, 132, 133. These drives may implement data storage using RAID techniques. Cores 115, 116, 125, 126 implement RAID techniques using the set of drives 130, 131, 132, 133. In communicating with the drives using these RAID techniques, the same N sectors from each drive are grouped together in a stripe. Each drive 130, 131, 132, 133 in the stripe contains a single “strip” of N data sectors. Depending upon the RAID level that is implemented, a stripe may contain mirrored copies of data (RAID1), data plus parity information (RAID5), data plus dual parity (RAID6), or other combinations. It would be understood by one having ordinary skill in the art how to implement the present technique with all RAID configurations and technologies.

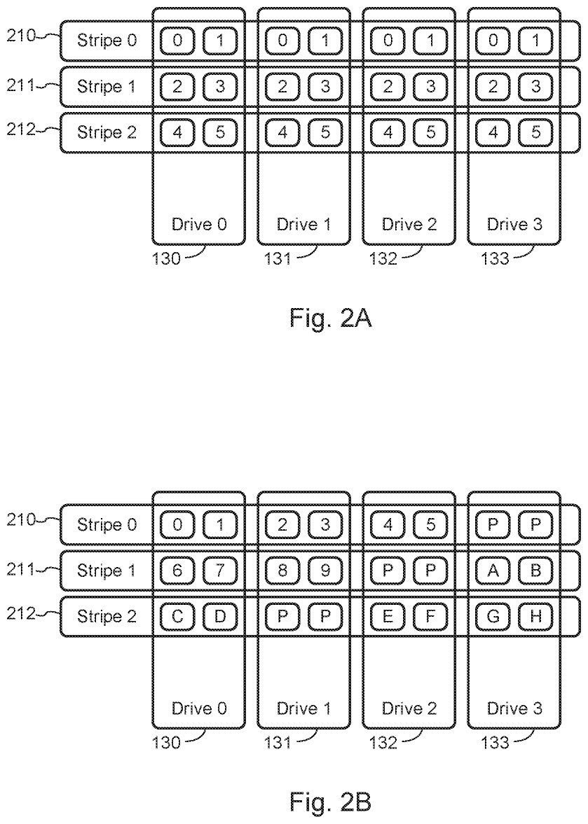

The present embodiments implement RAID techniques in a novel way that is not contemplated in conventional techniques. It will therefore be useful to describe examples of the conventional techniques. In each of these conventional techniques, the data is written to the drives in stripes, where a particular stripe is written to the same address of each drive. Thus, as shown in FIGS. 2A and 2B, Stripe 0 (210) is written at a first address in each of drives 130, 131, 132, 133, Stripe 1 (211) is written at a second address in each of the drives, and Stripe 2 (212) is written at a third address in each of the drives.

Referring to FIG. 2A, a conventional implementation of RAID level 1, or data mirroring, using the system of FIG. 1 is illustrated. In this example, six sectors of data (0-5) are written to the drives 130, 131, 132, 133. The data is mirrored to each of the drives. That is, the exact same data is written to each of the drives. Each of the drives has a strip size of N=2, so two sectors of data can be written to each drive in each stripe. As shown in the figure, for each drive, sectors 0 and 1 are written in stripe 0, sectors 2 and 3 are written in stripe 1, and sectors 4 and 5 are written in stripe 2. If a write is made to one of these sectors, it is necessary to write to the same sector on each of the drives.

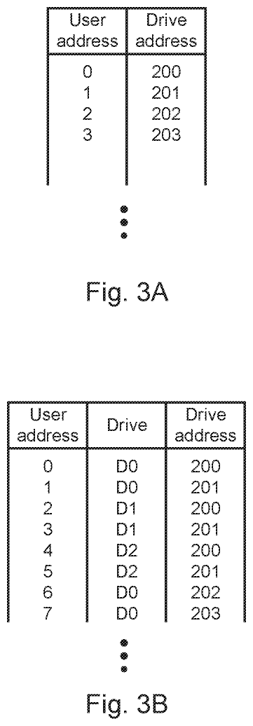

Referring to FIG. 3A, a diagram illustrating the contents of a metadata table structure for the user volume depicted by FIG. 2A is shown. This figure depicts a simple table in which the user volume address and offset of the stored data is recorded. For example, sectors 0 and 1 are stored at an offset of 200. Sectors 2 and 3 are stored at an offset of 202. Because the data is mirrored on each of the drives, it is not necessary to specify the drive on which the data is stored. This metadata may alternatively be compressed to:
User Volume V
Starting offset: 200
Drives: D0, D1, D2, D3
Encoding: RAID1
Strip size: 2

Referring to FIG. 2B, a conventional implementation of RAID level 5 is shown. Again, Stripe 0 (210) is written at a first address in each of drives 130, 131, 132, 133, Stripe 1 (211) is written at a second address in each of the drives, and Stripe 2 (212) is written at a third address in each of the drives. Also as in the example of FIG. 2A, the strip of each drive corresponding to Stripe 0 contains two sectors.

In a RAID 5 implementation, the system does not write the same data to each of the drives. Instead, different data is written to each of the drives, with one of the drives storing parity information. Thus, for example, Stripe 0 contains sectors 0-5 of data (stored on drives 130, 131, 132), plus two sectors of parity (stored on drive 133). The parity information for different stripes may be stored on different ones of the drives. If any one of the drives fails, the data (or parity information) that was stored on the failed drive can be reconstructed from the data and/or parity information stored on the remaining three drives.

Referring to FIG. 3B, a diagram illustrating the contents of a metadata table structure for the user volume depicted by FIG. 2B is shown. This figure depicts a simple table in which the user volume address, drive and offset of the stored data is recorded. In this example, sectors 0 and 1 are stored on Drive 0 at an offset of 200. Sectors 2 and 3, which are stored in the same stripe as sectors 0 and 1 are stored on Drive 1 at an offset of 200. This metadata may alternatively be compressed to:
User Volume V
Starting offset: 200
Drives: D0, D1, D2, D3
Encoding: RAID5
Strip size: 2

If data is written to one of the stored sectors on a RAID 5 system, the corresponding parity information must also be written. Consequently, a small random IO (data access) on this system requires reading both the old data and old parity to compute the updated parity. For RAID 5, that translates a single sector user's write into 2 read sectors (old data and old parity) and 2 writes (new data and new parity).

The traditional RAID systems illustrated in FIGS. 2A and 2B encode parity information across a set of drives, where the user's data address implicitly determines which drive will hold the data. This is a type of direct mapping—the user's data address can be passed through a function to compute the drive and drive address for the corresponding sector of data. As the RAID system encodes redundant information, sequential data sectors will be striped across multiple drives to achieve redundancy (e.g., through the use of mirroring or parity information) added on 1 or more additional drives.

Some software systems can perform address remapping, which allows a data region to be remapped to any drive location by using a lookup table (instead of a mathematical functional relationship). Address remapping requires metadata to track the location (e.g., drive and drive address) of each sector of data, so the compressed representation noted above for sequential writes as in the examples of FIGS. 2 and 3 cannot be used. The type of system that performs address remapping is typically still constrained to encode data on a fixed number of drives. Consequently, while the address or location of the data may be flexible, the number of drives that are used to encode the data (four in the examples of FIGS. 2A and 2B) is not.

One of the advantages of being able to perform address remapping is that multiple write IOs that are pending together can be placed sequentially on the drives. As a result, a series of back-to-back small, random IOs can “appear” like a single large IO for the RAID encoding, in that the system can compute parity from the new data without having to read the previous parity information. This can provide a tremendous performance boost in the RAID encoding.

In the present embodiments, writes to the drives do not have the same constraints as in conventional RAID implementations as illustrated in FIGS. 2A and 2B. Rather than striping data across a fixed number of drives at the same address on each drive, each user write indicates an “extent”, which for the purposes of this disclosure is defined as an address and a length of data. The address is the address in the user volume, and the length is the length of the data being written (typically a number of sectors). The data is not necessarily written to a fixed number of drives, and Instead of being striped across the same location of each of the drives, the data may be written to different locations on each different drive. Embodiments of the present invention also differ from conventional implementations in that each user write is encoded with an appropriate redundancy level, where each write may potentially use a different RAID encoding algorithm, depending on the write size and the service level definition for the write.

Embodiments of the present invention move from traditional RAID techniques which are implementation-centric (where the implementation constrains the user) to a customer-centric techniques, where each user has the flexibility to define the service level (e.g., redundancy and access speed) for RAID data storage. The redundancy can be defined to protect the data against a specific number of drive failures, which typically is 0 to 2 drive failures, but may be greater. The method by which the redundancy is achieved is often irrelevant to the user, and is better left to the storage system to determine. This is a significant change from legacy systems, which have pushed this requirement up to the user. In embodiments disclosed herein, the user designates a service level for a storage volume, and the storage system determines the most efficient type of RAID encoding for the desired service level and encodes the data in a corresponding manner.

The service level may be defined in different ways in different embodiments. In one exemplary embodiment, it includes redundancy and access speed. The redundancy level determines how many drive failures must be handled. For instance, the data may have no redundancy (in which case a single drive failure may result in a loss of data), single redundancy (in which case a single drive failure can be tolerated without loss of data), or greater redundancy (in which case multiple drive failures can be tolerated without loss of data). Rather than being constrained to use the same encoding scheme and number of drives for all writes, the system may use any encoding scheme to achieve the desired level of redundancy (or better). For example, the system may determine that the data should be mirrored to a selected number of drives, it may parity encode the data for single drive redundancy, it may Galois field encode the data for dual drive redundancy, or it may implement higher levels of erasure encoding for still more redundancy.

As noted above, the service level in this embodiment also involves data access speed. Since data can be read from different drives in parallel, the access rates of the drives are cumulative. For example, the user may specify that IO read access of at least 1 GB/s is desired. If each drive can support IO reads at 500 MB/s, then it would be necessary to stripe the data across at least two of the drives to enable the desired access speed ((1 GB/s)/(500 MB/s)=2 drives). If IO read access of at least 2 GB/s is desired, the data would need to be striped across four 500 MB/s drives.

Based on the desired redundancy and access speed for a particular user, the storage system can determine the appropriate encoding and drive count that are needed for that user. It should be noted that the performance metric (access speed) can also influence the encoding scheme. As indicated above, performance tends to increase by using more drives. Therefore, the system may perform mirrored writes to 2 drives for one level of performance, or 3 drives for the next higher level of performance. In the second case (using 3 mirrored copies), meeting the performance requirement may cause the redundancy requirement to be exceeded. In another example, the system can choose a stripe size for encoding parity information based on the performance metric. For instance, a large IO can be equivalently encoded with a 4+1 drive parity scheme (data on four drives and parity information on one drive), writing two sectors per drive, or as a 8+1 parity encoding writing one sector per drive. By defining the service level in terms of redundancy and access speed, the storage system is allowed to determine the best RAID technique for encoding the data.

Each IO is remapped as an extent by also writing metadata. Writing metadata for an IO uses standard algorithms in filesystem design, and therefore will not be discussed in detail here. To be clear, although there are existing algorithms for writing metadata generally, these algorithms conventionally do not involve recording an extent associated with RAID storage techniques.

The remapping metadata in the present embodiments functions in a manner similar to a filesystem ‘inode’, where the filename is replaced with a numeric address and length for block based storage as described in this disclosure. Effectively, the user's address (the address of the IO in the user's volume of the storage system) and length (the number of sectors to be written) are used as a key (instead of filename) to lookup the associated metadata. The metadata may, for example, include a list of each drive and the corresponding address on the drive where the data is stored. It should be noted that, in contrast to conventional RAID implementations, this address may not be the same for each drive. The metadata may also include the redundancy algorithm that was used to encode the data (e.g., RAID 0, RAID 1, RAID 5, etc.) The metadata may be compressed in size by any suitable means.

The metadata provides the ability to access the user's data, the redundancy data, and the encoding algorithm. The metadata must be accessed when the user wants to read back the data. This implies that metadata is stored in a sorted data structure based on the extent (address plus length) key. The data structure is typically a tree structure, such as a B+TREE, that may be cached in RAM and saved to a drive for persistence. This metadata handling (but not the use of the extent key) is well-understood in file system design. It is also understood that data structures (trees, tables, etc.) other than a B+TREE may be used in various alternative embodiments. These data structures for the metadata may be collectively referred to herein as a metadata tree.

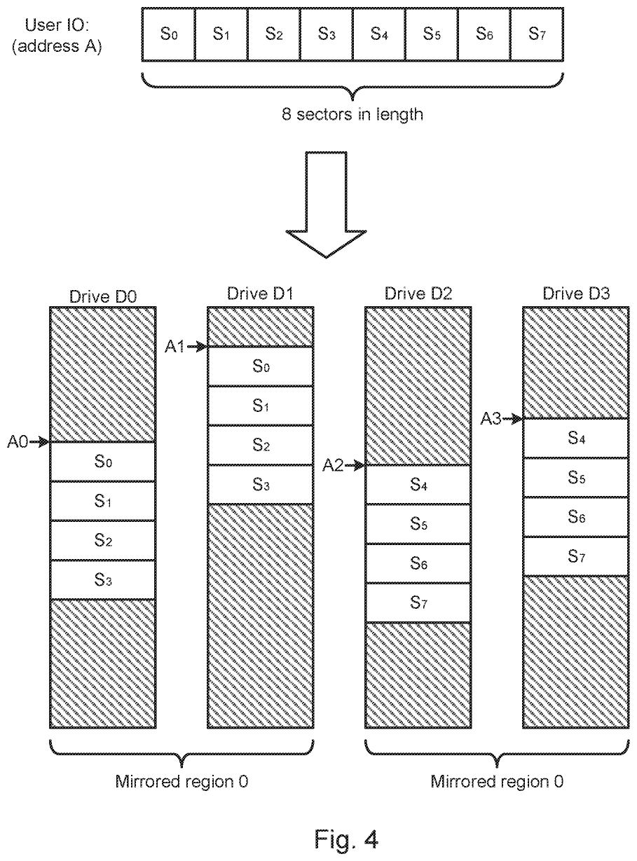

Following is an example of the use of one embodiment of a data storage system in accordance with the present disclosure. This example demonstrates a write IO in which the user designates a single drive redundancy with a desired access speed of 2 GB/s. The example is illustrated in FIG. 4.

Write IO

1. Volume V of the user is configured for a redundancy of 1 drive, and performance of 2 GB/s. It should be noted that performance may be determined in accordance with any suitable metric, such as throughput or latency. Read and write performance may be separately defined.

2. The user initiates a write IO to volume V, with address=A and length=8 sectors.

3. The storage system determines from the provided write IO information and the service level (redundancy and performance) information that data mirroring (the fastest RAID algorithm) is required to meet the performance objective.

4. The storage system determines that one drive can support 500 MB/s, therefore 4 drives are required in parallel to achieve the desired performance ([2 GB/s]/[500 MB/s per drive]=4 drives).

5. The storage system breaks the IO into 2 regions of 4 sectors each.

6. The storage system writes region 1 to drives 0 and 1, and region 2 to drives 2 and 3. This mirroring of each region achieves the 1 drive redundancy service level. The data stored on each of the drives may be stored at different offsets in each of the drives. It should also be noted that the write need not use all of the drives in the storage system—the four drives selected in this example for storage of the data may be only a subset of the available drives.

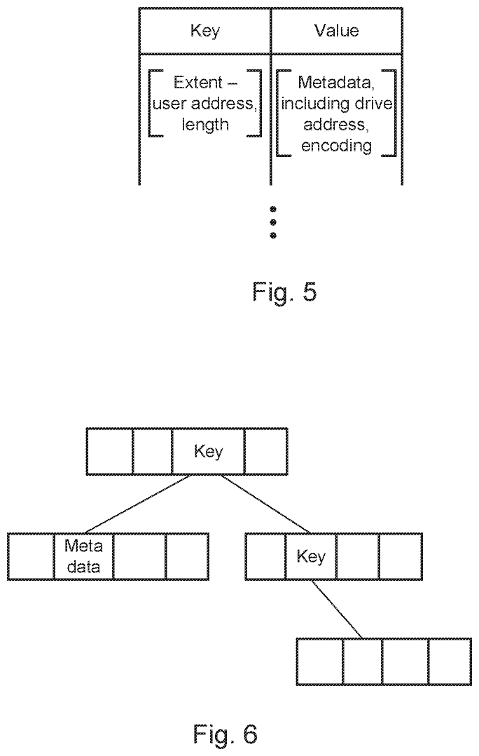

7. The storage system updates the metadata for user region address=A, length=8. The metadata includes the information: mirrored algorithm (RAID 0); length=4, drive D0 address A0 and drive D1 address A1; length=4, drive D2 address A2 and Drive D3 address A3. It should be noted that that drive addresses are allocated as needed, similar to a thin provisioning system, rather than allocating the same address on all of the drives. Referring to FIG. 5, the metadata may be stored in a table, tree or other data structure that contains key-value pairs, where the key is the extent (the user address and length of the data), and the value is the metadata (which defines the manner in which the data is encoded and stored on the drives). The keys will later be used to lookup the metadata, which will be used to decode and read the data stored on the drives.

8. The metadata is inserted into a key-value table (as referenced elsewhere) which is a data structure that uses a range of consecutive addresses as a key (e.g. address+length) and allows insert and lookup of any valid range. The implementation is unlikely to be a simple table—but rather a sorted data structure such as a B+TREE so that the metadata can be accessed for subsequent read operations. As noted above, the metadata In the example of FIG. 4, may be:

Region 0, mirror, length 4

| Drive | address |
|---|---|
| D0 | A0 |
| D1 | A1 |

Region 1, mirror, length 4

| Drive | address |
|---|---|
| D2 | A2 |
| D3 | A3 |

FIG. 6 illustrates a tree structure that can be used to store the keys and metadata values. As noted above, storing metadata in a data structure such as a tree structure is well-understood in file system design and will not be described in detail here. However, the specific features of the present embodiments such as the use of an extent (address, length) as a key, encoding the data according to a variable and selectable RAID technique and the storing the data on selectable drives at variable offsets, is not known in conventional storage systems.

9. If the user IO overwrote existing data, the metadata for the overwritten data is freed and the sectors used for this metadata are returned to the available capacity pool for later allocation.

10. If the user IO partially overwrote a previous write, the previous write may require re-encoding to split the region. This may be accomplished in several ways, including:
a. Rewriting the remaining portion of the previous IO with new encoding.
b. Rewriting just the metadata of the previous IO, indicating that a portion of the IO is no longer valid. (This is required for parity encodings.)
c. Updating the metadata of the previous IO, freeing unnecessary data sectors that were overwritten. (This is possible for mirrored encodings, as the old data is not required to rebuild the remaining portion of the IO.
d. Overwrites may be handled by a background garbage collection task, similar to NVME firmware controllers.

Following is an example of a read IO in one embodiment of a data storage system in accordance with the present disclosure. This example illustrates a read IO in which the user wishes to read 8 sectors of data from address A.

Read IO

1. User read IO with address=A, length=8 sectors from volume V.

2. The storage system performs a lookup of the metadata associated with the requested read data. The metadata lookup may return 1 or more pieces of metadata, depending on the size of the user writes according to which the data was stored. (There is 1 metadata entry per write in this embodiment.)

3. Based on the metadata, the software determines how to read the data to achieve the desired data rate. The data may, for example, be read from multiple drives in parallel if the requested data throughput is greater than the throughput achievable with a single drive.

4. The data is read from one or more drives according to the metadata retrieved in the lookup. This may involve reading multiple drives in parallel to get the requested sectors. If one of the drives has failed, the read process recognizes the failure and either selects a non-failed drive from which the data can be read, or reconstructs the data from the one or more of the non-failed drives.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions or rearrangements may be made within the scope of the invention, and the invention includes all such substitutions, modifications, additions or rearrangements.

One embodiment can include one or more computers communicatively coupled to a network. As is known to those skilled in the art, the computer can include a central processing unit (“CPU”), at least one read-only memory (“ROM”), at least one random access memory (“RAM”), at least one hard drive (“HD”), and one or more I/O device(s). The I/O devices can include a keyboard, monitor, printer, electronic pointing device (such as a mouse, trackball, stylus, etc.), or the like. In various embodiments, the computer has access to at least one database over the network.

ROM, RAM, and HD are computer memories for storing computer-executable instructions executable by the CPU. Within this disclosure, the term “computer-readable medium” is not limited to ROM, RAM, and HD and can include any type of data storage medium that can be read by a processor. In some embodiments, a computer-readable medium may refer to a data cartridge, a data backup magnetic tape, a floppy diskette, a flash memory drive, an optical data storage drive, a CD-ROM, ROM, RAM, HD, or the like.

At least portions of the functionalities or processes described herein can be implemented in suitable computer-executable instructions. The computer-executable instructions may be stored as software code components or modules on one or more computer readable media (such as non-volatile memories, volatile memories, DASD arrays, magnetic tapes, floppy diskettes, hard drives, optical storage devices, etc. or any other appropriate computer-readable medium or storage device). In one embodiment, the computer-executable instructions may include lines of compiled C++, Java, HTML, or any other programming or scripting code.

Additionally, the functions of the disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols.

As used herein, the terms “comprises,” “comprising,” “includes,” “including,” “has,” “having” or any other variation thereof, are intended to cover a non-exclusive inclusion. For example, a process, product, article, or apparatus that comprises a list of elements is not necessarily limited only those elements but may include other elements not expressly listed or inherent to such process, product, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations includes, but is not limited to: “for example”, “for instance”, “e.g.”, “in one embodiment”.

In the foregoing specification, the invention has been described with reference to specific embodiments. However, one of ordinary skill in the art appreciates that various modifications and changes can be made without departing from the scope of the invention as set forth. Accordingly, the specification and figures are to be regarded in an illustrative rather than a restrictive sense, and all such modifications are intended to be included within the scope of invention.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component.

What is claimed is:

1. A system for RAID storage of data, the system comprising:
a plurality of storage drives; and
a storage engine coupled to the storage drives;
wherein the storage engine is configured to receive from a user one or more write requests to write data on one or more of the plurality of storage drives, each of the one or more requests identifying a corresponding starting user address and a length of data to be written on the storage drives; and
wherein for each write request, the storage engine is configured to
determine, based at least in part on the identified length of the data to be written, a corresponding RAID encoding,
determine, based at least in part on the identified user address, one or more corresponding physical addresses at which the data will be written on the plurality of storage drives, and
store the data on the plurality of storage drives at the one or more corresponding physical addresses.

2. The system of claim 1, wherein the storage engine is further configured to determine the RAID encoding corresponding to each write request based at least in part on a service level indicated by the user, wherein the service level includes a redundancy level.

3. The system of claim 1, wherein the storage engine is further configured to determine, for each write request, the corresponding physical addresses at which the data will be written on the plurality of storage drives based on availability of storage space on the plurality of storage drives.

4. The system of claim 3, wherein the physical addresses corresponding to the write request comprise different physical addresses on different ones of the plurality of storage drives.

5. The system of claim 1, wherein the plurality of storage drives comprises a total number N of the storage drives, and wherein for at least one of the one or more write requests, the corresponding data is written to a number M of the N storage drives, wherein M is less than N.

6. The system of claim 1, wherein the storage engine is configured to maintain a metadata tree, wherein for each write request, the metadata tree includes a corresponding entry wherein a key of the entry comprises the user address and a value of the entry comprises the one or more corresponding physical addresses.

7. The system of claim 6, wherein the value further comprises the corresponding RAID encoding.

8. The system of claim 6,
wherein the storage engine is configured to receive from a user one or more read requests to read data from one or more of the plurality of storage drives, each of the one or more requests identifying a corresponding starting user address and a length of data to be read from the storage drives; and
wherein for each read request, the storage engine is configured to
identify an entry of the metadata tree having the user address as the key,
identify the one or more physical addresses corresponding to the identified entry,
identify a RAID encoding corresponding to the identified entry, and
read the data from the plurality of storage drives at the one or more corresponding physical addresses.

9. The system of claim 1, wherein for a first one of the one or more write requests the storage engine is configured to determine a corresponding first RAID encoding, and wherein for a second one of the one or more write requests the storage engine is configured to determine a corresponding second RAID encoding which is different from the first RAID encoding.

10. A method for RAID storage of data, the method comprising:
in a data storage system having a plurality of storage drives,
receiving one or more write requests to write data on one or more of the plurality of storage drives, each of the one or more requests identifying a corresponding starting user address and a length of data to be written on the storage drives; and
for each of the one or more write requests,
determining, based at least in part on the identified length of the data to be written, a corresponding RAID encoding,
determining, based at least in part on the identified user address, one or more corresponding physical addresses at which the data will be written on the plurality of storage drives, and
storing the data on the plurality of storage drives at the one or more corresponding physical addresses.

11. The method of claim 10, further comprising determining the RAID encoding corresponding to each write request based at least in part on a service level indicated by the user, wherein the service level includes a redundancy level.

12. The method of claim 10, further comprising determining, for each write request, the corresponding physical addresses at which the data will be written on the plurality of storage drives based on availability of storage space on the plurality of storage drives.

13. The method of claim 12, wherein the physical addresses corresponding to the write request comprise different physical addresses on different ones of the plurality of storage drives.

14. The method of claim 10, wherein the plurality of storage drives comprises a total number N of the storage drives, and wherein for at least one of the one or more write requests, the corresponding data is written to a number M of the N storage drives, wherein M is less than N.

15. The method of claim 10, further comprising maintaining a metadata tree, wherein for each write request, the metadata tree includes a corresponding entry wherein a key of the entry comprises the user address and a value of the entry comprises the one or more corresponding physical addresses.

16. The method of claim 15, wherein the value further comprises the corresponding RAID encoding.

17. The method of claim 15, further comprising
receiving from a user one or more read requests to read data from one or more of the plurality of storage drives, each of the one or more requests identifying a corresponding starting user address and a length of data to be read from the storage drives; and
for each read request,
identifying an entry of the metadata tree having the user address as the key,
identifying the one or more physical addresses corresponding to the identified entry,
identifying a RAID encoding corresponding to the identified entry, and
reading the data from the plurality of storage drives at the one or more corresponding physical addresses.

18. The method of claim 10, further comprising:
determining, for a first one of the one or more write requests, a corresponding first RAID encoding, and
determining, for a second one of the one or more write requests, a corresponding second RAID encoding which is different from the first RAID encoding.
